(19) United States
(12) Patent Application Publication
(10) Pub. No.: US 2004/0165732 A1
(43) Pub. Date: Aug. 26, 2004

(54) Speaker system and method for selectively activating speakers

(75) Inventors: Angelo S. Arcaria, Wethersfield, CT (US); Gene Pecora, Farmington, CT (US)

Correspondence Address: BAKER & HOSTETLER LLP, Washington Square, Suite 1100, 1050 Connecticut Avenue, N.W., WASHINGTON, DC, 20036, US

(73) Assignee: Edwards Systems Technology, Inc.

(21) Appl. No.: 10/368,638

(22) Filed: Feb. 20, 2003

(51) Int. Cl. H04B 3/00

(52) U.S. Cl. 381/81

(57) ABSTRACT

A speaker system such as a public address system and a method of operation is provided. The system includes a controller and a speaker with a unique identifying address. The system may provide diagnostic information regarding a specific speaker to the controller. The method of operation of the system includes assigning a unique address to a speaker, providing communication between the speaker and a controller via an audio loop, providing communication between the speaker and the controller via a communication loop.

### FIELD OF THE INVENTION

The present invention relates generally to public address systems. More particularly, the present invention relates to a method and apparatus for selectively operating and monitoring the function of specific speakers in a public address system.

### BACKGROUND OF THE INVENTION

In industrial and commercial public address systems, a plurality of audio speakers are often located throughout a building or facility. The speakers are often connected to a common controller for activating and providing audio signals for the speakers. In some public address systems, groups of speakers may be divided into zones and wired accordingly so that certain groups of speakers or certain zones may be selectively activated. The zone configurations allow the public address system to only activate certain groups of speakers and not the entire system. For example, a multifloored building may have the speakers on each floor set up as a zone. The speakers on a certain floor could then be activated without activating the speakers on other floors. Alternatively, all the zones can be selected so that all of the speakers attached to the public address system can be activated.

In some speaker systems using a zone configuration, each zone is wired with its own audio loop. Multiple zones which use multiple audio loops causes increased expense in material and labor in installing multiple loops.

Accordingly, a speaker system capable of having multiple zones and configured to need only a single audio loop is desired.

Some electronic paging systems or public address systems can be electronically supervised for system integrity. For supervised systems, trouble detection for any of the zones may be accomplished by use of an end of line resistor (EOLR). EOLRs are commonly placed at the end of a wire loop connecting the speakers to a specific zone. When a fault in the zone occurs, with the help of the EOLR, the public address system may be able to detect a fault is occurring in a specific zone, but may be unable to detect where precisely within the zone the fault occurs.

Accordingly, it is desirable to provide a speaker system that is monitoring the speakers in such a way that when a fault occurs within a specific speaker, the speaker system can detect which speaker is malfunctioning.

### SUMMARY OF THE INVENTION

It is therefore a feature and advantage of some embodiments of the present invention to provide a speaker system capable of selectively causing certain speakers to broadcast in zone type manner using only a single audio loop.

It is also a feature and advantage of some embodiments of the present invention to provide a speaker system capable of selectively activating zones of speakers and electronically monitoring the performance of the speakers on an individual basis.

The above and other features and advantages are achieved through the use of a novel speaker system and method of operation as herein disclosed. In accordance with one embodiment of the present invention, a speaker system is provided. The speaker system includes a controller, at least one speaker having a unique identification and is at least one of individually identifiable and individually controllable, an audio loop connecting the at least one speaker to the controller, and a communications loop connecting the at least one speaker to the controller.

In accordance with another embodiment of the present invention, a speaker is provided. The speaker includes an audio input configured to receive an input signal and generate an audio signal, a speaker output device configured to broadcast sound, a control input device configured to receive a control signal and selectively control whether the speaker output device broadcasts a sound, wherein the speaker has a unique identification and is at least one of individually identifiable and individually controllable.

In accordance with another embodiment of the present invention, a speaker system is provided. The speaker system includes means for controlling the system, means for broadcasting, having a unique identification and is at least one of individually identifiable and individually controllable, means for providing communication between the controlling means and the broadcasting means.

In accordance with another embodiment of the present invention, a speaker is provided. The speaker includes means for receiving an input signal and generating an audio signal, means for broadcasting configured to broadcast sound, means for regulating configured to receive a control signal and selectively control whether the broadcasting means broadcasts a sound, wherein the speaker has a unique identification and is at least one of individually identifiable and individually controllable.

In accordance with another embodiment of the present invention, a method for operating a speaker system is provided. The method includes assigning a unique address to a speaker, providing communication between the speaker and a controller via an audio loop, providing communication between the speaker and the controller via a communication loop.

There has thus been outlined, rather broadly, some of the features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram of a speaker system in accordance with one embodiment of the invention having a multiple zone configuration.

FIG. 2 is a schematic diagram of a speaker system in accordance with one embodiment of the invention having a controller, a tone generator, and speakers.

FIG. 3 is a schematic diagram of a speaker in accordance with one embodiment of the invention.

### DETAILED DESCRIPTION OF PREFERRED EMBODIMENTS OF THE INVENTION

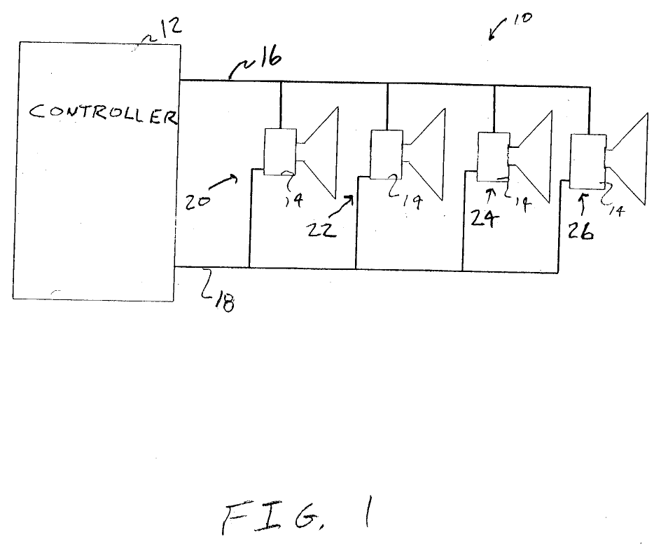

Turning now to the figures, where like elements are denoted by like reference numerals, FIG. 1 is a diagram of an exemplary public address system 10 in accordance with one embodiment of the present invention. The public address system 10 includes a controller 12, connected to several speakers 14. The speakers 14 are connected to the controller 12 by an audio loop 16 and a communications loop 18. In some embodiments of the invention the audio loop 16 and/or the communications loop 18 may not comprise wire connections, but may be wireless.

According to some embodiments of the present invention, the speaker system 10 may configure the speakers 14 into different zones. While the embodiment in FIG. 1 shows only one speaker 14 per zone, many embodiments of the present invention will contain several speakers having the same zone identifier. An example of a zone configuration is shown by numerals 20, 22, 24, 26 where each numeral represents a zone in FIG. 1. System 10 may have as many or as few zones as needed for a particular installation.

According to some embodiments of the present invention, each speaker 14 has a zone identifier and a unique individual identifier. More than one speaker 14 may have the same zone identifier. When speakers 14 have the same zone identifier, they are considered to be in the same zone. When the controller 12 activates a certain zone all the speakers 14 within that zone (i.e., having the same zone identifier) will simultaneously broadcast.

The zone address may be assigned and modified by the system 10. For example, a system user may use the controller 12 to identify a specific speaker 14 and assign that speaker a zone. The controller 12 will then assign that speaker the zone identifier in accordance with the assigned zone. The speaker 14 may be modified to change its zone identifier at different times according to the needs of a specific installation.

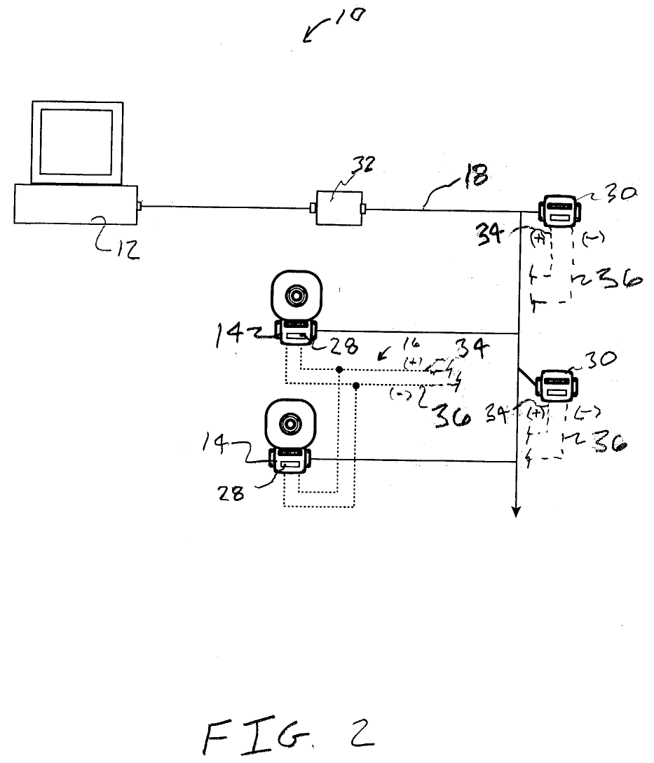

According to some embodiments of the present invention, the speakers 14 have unique identifying addresses. The unique identifying address may permit the controller 12 to identify and activate a speaker 14 individually. For example, each speaker 14 may have an external switch 28 (FIG. 2), such as a dip switch which may permit a certain switch configuration to be implemented on each speaker 14. The switch configuration may determine the individual speaker 14 identification. The address may be modified or changed by altering the switch configuration.

In addition, the switch 28 may permit selection of a Baud rate for the system 10. While higher Baud rates permit faster transmission of data across the system, certain systems can have limitations or features such as long transmission lines that will allow the system 10 function better at lower Baud rates. For example, the system Baud rate may be set for values of 1200, 2400, 9600, and 19200.

Other embodiments of the present invention may permit each speaker 14 to have an electronic identification which may be integrated into the speaker 14 and the electronic identification may be modified by the controller 12. In some embodiments of the present invention, the unique identification is communicated to the controller 12 via the communication loop 18. Some embodiments of the invention may permit the address of a speaker 14 to be modified by the controller 12. When a speaker 14 can have its unique address or zone changed by the controller 12, the speaker 14 is dynamically programmable.

FIG. 2 is an exemplary illustration of one embodiment of the present invention. In FIG. 2 the controller 12 is a computer. The controller 12 may be personal computer (“PC”) such as an IBM compatible computer for example, or it may be a program logic controller or any other type of microcontroller suitable for such an application. The controller 12 may include a means for inputting information into the controller. For example, the controller 12 may include a keyboard or other means known in the art for inputting information. A system 10 user may input information into the controller 12 to operate the system 10. For example, the user may input which zones to activate to broadcast. The user may select tones to broadcast and the controller 12 may cause the tone generator 30 to generate certain tones. The user may speak or otherwise input an audio signal into a microphone operably connected to the controller and cause the system 10 to broadcast the operator's audio input.

The communication loop 18 may include an adapter 32 which may be configured to adapt a signal output by the controller 12 to a signal that may be input into the speaker 14. For example, the adapter 32 may be an analog-to-digital transformer.

In some embodiments of the present invention, as shown in FIG. 2, a tone generator 30 is attached to the communications loop 18. A tone generator 30 may be used to generate certain tones for the public address system. For example, it may generate a specific tone for a fire alarm, another tone for a security alarm, and it may generate specific tones for other types of emergency alarms. The system 10 may include sensors connected to the system and configured to set off the emergency alarms when the sensors detect emergencies. In addition, the system 10 may contain a pre-recorded verbal message. In some embodiments of the present invention a tone generator 30 may be attached to the communications loop 18 and/or the audio loop 16. The controller 12 may cause the tone generator 30 to activate and send audio signals to all zones of speakers 14 in the system 10. The audio loop 16 may include of a positive and negative line 34 and 36.

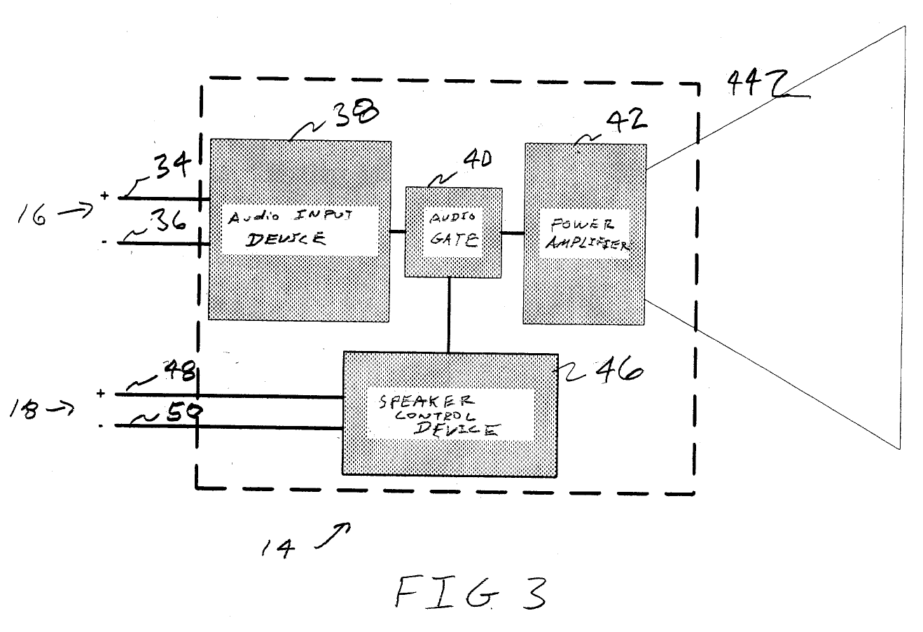

The speaker 14, as illustrated in FIG. 3, may have a variety of components. The speaker 14 may include an audio input device 38. The audio loop 16 may input an audio signal to the input device 38. The audio input device 38 may be an audio input and pre-amplifier. The audio input device 38 may convert the signal from the audio loop 16 positive and negative leads 34, 36 into a signal and send that signal into an audio gate 40. The audio gate 40 may be configured to pass the signal from the audio input device 38 directly into a power amplifier 42 which may amplify the signal from the audio input device 38 so that it may be broadcast via the broadcasting device 44 (also referred to as a speaker output device). (While the term “speaker” is often used to describe a broadcasting device 44, in this document the term “speaker” may refer generally to several components identified generally by reference numeral 14 which include a broadcasting device 44.)

The audio gate 40 may be configured to selectively pass and not pass the signal from the audio input device 38 into the power amplifier 42. The audio gate 40 may be controlled by a speaker control device 46 to control whether the audio gate 40 passes or does not pass the signal from the audio input device 38 to the power amplifier 42.

In accordance with another embodiment of the present invention, the audio control device 46 may be a transceiver protocol decoder. The control device 46 (FIG. 3) may include a microcontroller that permits the control device to communicate with the controller 12. The audio control device 46 may be connected to the communications loop 18 which may have a positive transmission and receiving line 48 and a negative transmission and receiving line 50. In some embodiments of the invention, the speaker 14 may be activated to broadcast by the controller 12 (FIG. 1) calling for a specific zone to broadcast. In other embodiments, the speaker 14 may be activated by the zone and/or unique address being called to broadcast. The controller 12 may also send a signal via the communications loop 18 to the individual speaker controller 46 (FIG. 3) to control the audio gate 40 based not only on zone identification but identifying a particular speaker 14 by its unique identifying address. In other words, there may be situations where the controller 12 causes a single speaker rather than an entire zone to broadcast.

If the communications loop 18 identifies either the zone identifier or the individual identifier of the speaker 14, the speaker control device 46 may permit the audio gate 40 to pass the signal from the audio input device 24 into the power amplifier 42. For example, if the particular speaker 14 contains the zone identifier that the controller 12 (FIG. 1) is calling to broadcast, then the communications loop 18 will give a signal to the speaker control device 46 (FIG. 3) that will in turn send a signal to the audio gate 40 that will permit the audio gate 40 to pass the audio input signal from the audio input device 38 directly into the power amplifier 42. However, if the controller 12 calls for a particular speaker 14 to not broadcast, (by not selecting the zone or individual address of a particular speaker to broadcast) then the communications loop 18 will provide a signal to the speaker controller 46 to cause the audio gate 40 to not pass the signal from the audio input device 38 into the power amplifier 42.

According to some embodiments of the present invention, if there is a fault within a speaker 14, then the speaker control device 46 may send a signal via the communications loop 18 to the controller 12 informing the controller 12 that a particular speaker 14 has a fault. A particular speaker may be identified to the controller 12 by providing the unique identifying address to the controller 12 of the speaker 14 having the fault.

For example, the integrity of the audio loop 16 may be tested by the controller 12 using an EOLR. When the system 10 is not broadcasting an audio signal (known as idol time), the system 10 runs a DC current through the audio loop 16. The speakers 14 may have a blocker such as a blocking capacitor which may be configured to prevent the audio current from activating the speakers 14. The DC current runs through the audio loop 16, the EOLR, and back to the controller 12.

In some embodiments of the invention, the controller 12 contains an analog to digital converter that takes 50 rapid samples of the voltage associated with the return current and compares the voltage with a look up table contained in the controller 12. The look up table contains the amount of voltage the controller 12 should expect to have returned. The controller 12 compares the return current voltage to the values contained in the look up table and determines if the return current voltage is within an acceptable range. If there is a problem in the audio loop 16, the EOLR may modify the current sent back to the controller 12, thus informing the controller 12 there is a problem in the audio loop 16. Alternatively, shorts or breaks in the system will also affect what current is returned to the controller 12.

In some embodiments of the invention, the controller 12 can diagnose audio loop 16 problems based on the return current voltage. The diagnoses can be preformed by comparing the returned current voltage with a look up table that prompts the controller to make certain diagnoses for particular return current voltage values. For example, if there is no return current, the controller 12 may determine that there is a break in the audio loop 16. When the return current voltage is too high, the controller 12 may determine that there is a short in the audio loop 16. If the return current voltage is too low, the controller may determine that there is a capacitor problem in the audio loop 16. While the current example discusses monitoring the return current voltage, one skilled in the art will appreciate that other features of the return current may also be monitored to perform a similar function.

The system 10 can also test the audio loop 16 during times when the audio loop 16 is active. For example, the controller 12 can break the audio signal and send a test DC current through the audio loop 16 in a similar manner described above. Preferably, the controller will break the audio signal every 15 seconds to send the DC current through the audio loop 16.

Additional system integrity may be checked or monitored. For example, if a speaker 14 is not receiving power or is using battery back up power, the speaker 14 may send a signal to the controller 12 informing the controller 12 of the problem. The speaker 14 may include its unique identifier address so the controller 12 will know which speaker is having the problem.

According to some embodiments of the present invention, the speaker 14 will only provide information regarding faults to the controller 12 when the controller 12 sends a signal to the speakers 14 requesting a response whether each speaker 14 contains a fault. For example, the controller 12 may send the signal via the communications loop 18. The process of the controller 12 sending out a signal requesting that the speakers 14 provide information regarding faults is known as providing diagnostics to the controller 12 on a “poll by poll” basis.

In order to test and insure the operability of the speakers 14, the controller 12 may use a protocol which may include a list of diagnostics and or control commands which it sends to the speakers 14 through the audio 16, or preferably communication loop 18. The speakers 14 may respond to the controller's diagnostic signals using the unique identifying address to inform the controller 12 if any of the speakers 14 have faults.

For example, the controller 12 can contain a map of the system including all of the speakers 14 and zone affiliations of the speakers 14. In some embodiments of the invention, when the controller 12 sends out a poll command, the controller 12 requests each speaker to respond using its unique address and zone address. The controller 12 reassigns each speaker 14 its zone affiliation, confirms the speaker's unique address, and inquires to the power status of the speaker as to whether the speaker 14 is operating on under normal power, back up or battery power. The feature of the controller 12 reassigning the zone address of a speaker 14 is called dynamic zoning. In dynamic zoning, the controller 12 will reassign the speaker 14 the same zone address it had before, or a new zone address depending on the needs of the system as input to the controller 12.

The controller 12 can also request speakers 14 to identify themselves. The controller 12 may then check the identified speakers 14 against the system map the controller 12 has and determine if there are any new speakers 14 added to the system or speakers 14 that are not responding. If a speaker 14 does not respond, the controller 12 will repeat the poll command, preferably five times. If the speaker 14 does not respond after the fifth time, the controller 12 will acknowledge that there is a communication error and report the error to a system operator. If new speakers 14 are added to the system 10, the controller 12 can amend the map to reflect the new speakers 14. The controller may request speaker configuration information from the speakers 14 such as what tone or tones the speaker 14 will broadcast, what zone speaker 14 is in, what relays are associated with the speaker 14 in the system 10. The controller 12 may record this information and associated with each speaker 14 by the speaker's unique address.

In order to check to ensure that the speakers 14 and the controller 12 are communicating properly, the controller 12 and speakers 14 may exchange a check sum. For example, after sending a message to a speaker 14, the controller 12 will send a sum to the speaker 14. The speaker 14 will add the hex bites in the message and that total should equal the sum send by the controller 12. The opposite is also true, the speaker 14 may send a sum to the controller 12 and the controller will add the hex bites contained in the message from the speaker 14. If the two sums do not match, the message may be sent again, preferablely, the message will be sent up to five times. If the two sums continue to not match, the controller 12 will generate a communication error message to a system operator.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A speaker system comprising:
a controller;
at least one speaker having a unique identification and is at least one of individually identifiable and individually controllable;
an audio loop connecting the at least one speaker to the controller; and
a communications loop connecting the at least one speaker to the controller.

2. The system of claim 1, wherein the at least one speaker has a zone identification and the controller controls a zone of speakers.

3. The system of claim 2, wherein the controller communicates with the at least one speaker by at least one of the zone identification and the unique identification.

4. The system of claim 1, wherein the at least one speaker is configured to provide diagnostic information to the controller.

5. The system of claim 1, wherein the unique identification associated with the at least one speaker is configured to be dynamically programmable.

6. The system of claim 1, wherein the at least one speaker further comprises:
an audio input and pre-amplifier configured to receive audio input from the audio loop and generate an audio signal;
an audio gate configured to receive the audio signal from the audio input and pre-amplifier;
a power amplifier configured to receive the audio signal from the audio gate and amplify the audio signal for input to a speaker output device; and
a transceiver and protocol decoder configured to receive a control signal and selectively manipulate the audio gate to input and not input the audio signal to the power amplifier.

7. The system of claim 6, wherein the control signal is generated by the controller.

8. The system of claim 7, wherein the transceiver and protocol decoder is configured to communicate diagnostic information to the controller.

9. The system of claim 8, wherein transceiver and protocol decoder communicates with the controller via the communication loop.

10. A speaker comprising:
an audio input configured to receive an input signal and generate an audio signal;
a speaker output device configured to broadcast sound; and
a control input device configured to receive a control signal and selectively control whether the speaker output device broadcasts a sound,
wherein the speaker has a unique identification and is at least one of individually identifiable and individually controllable.

11. The speaker of claim 10, wherein the speaker has a zone identification and the speaker is identifiable and controllable to a controller by the zone identification.

12. The speaker of claim 10, wherein the speaker is configured to provide diagnostic information to a controller.

13. The speaker of claim 10, wherein the unique identification associated with the speaker is configured to be dynamically programmable.

14. The speaker of claim 10 further comprising:
an audio gate configured to receive the audio signal from the audio input; and
a power amplifier configured to receive the audio signal from the audio gate and amplify the audio signal for input to the speaker output device,
wherein the audio input is an audio input and pre-amplifier configured to receive the input signal and generate the audio signal,
wherein the control input device is a transceiver and protocol decoder configured to receive the control signal and selectively manipulate the audio gate to input and not input the audio signal to the power amplifier.

15. The speaker of claim 14, wherein the transceiver and protocol decoder is configured to communicate diagnostic information to a speaker controller.

16. A speaker system comprising:
means for controlling the system;
means for broadcasting having a unique identification and is at least one of individually identifiable and individually controllable; and
means for providing communication between the controlling means and the broadcasting means.

17. The system of claim 16, wherein broadcasting means has a zone identification and the broadcasting means is identifiable and controllable by the zone identification.

18. The system of claim 16, wherein the broadcasting means is configured to provide diagnostic information to the controlling means.

19. The system of claim 16, wherein the unique identification associated with the broadcasting means is configured to be dynamically programmable.

20. A speaker comprising:
means for receiving an input signal and generating an audio signal;
means for broadcasting configured to broadcast sound; and
means for regulating configured to receive a control signal and selectively control whether the broadcasting means broadcasts a sound,
wherein the speaker has a unique identification and is at least one of individually identifiable and individually controllable.

21. The speaker of claim 20, having a zone identification and the speaker is identifiable and controllable by the zone identification.

22. The system of claim 20, wherein the speaker is configured to provide diagnostic information to a controller.

23. The system of claim 20, wherein the unique identification associated with the speaker is configured to be dynamically programmable.

24. A method of operating a speaker system comprising the steps of:
assigning a unique address to a speaker;
providing communication between the speaker and a controller via an audio loop; and
providing communication between the speaker and the controller via a communication loop.

25. The method of claim 24, further comprising assigning a zone address to the speaker and controlling the speaker by calling for the speaker to broadcast using at least one of the unique address and the zone address.

26. The method of claim 25, wherein at least one of the unique address and the zone address is assignable to the speaker via an external switch capable of multiple settings.

27. The method of claim 24, further comprising providing diagnostic information about the speaker to the controller using the speaker's unique address.

28. The method of claim 27, further comprising providing the diagnostic information to the controller when the controller requests diagnostic information.
